(19) United States
(12) Patent Application Publication
(10) Pub. No.: US 2011/0204306 A1
(43) Pub. Date: Aug. 25, 2011

(54) RATCHETED PULLEY APPARATUS

(75) Inventor: Kenneth Kingery, Mesa, AZ (US)

(73) Assignee: Quickie Tie-Down Enterprises, Inc., Mesa, AZ (US)

(21) Appl. No.: 13/056,242

(22) PCT Filed: Jul. 29, 2009
(86) PCT No.: PCT/US2009/052162

§ 371 Date: Mar. 23, 2011

Related U.S. Application Data
(60) Provisional application No. 61/084,490, filed on Jul. 29, 2008.

(51) Int. Cl. B66D 3/04

(52) U.S. Cl. 254/391

(57) ABSTRACT

An apparatus and a system for improving rope tie downs is provided. The apparatus includes a new design whereby the apparatus has a thick walled nylon, aluminum and/or stainless steel body, with a tangential rib opposing the face wheel. The apparatus may have a gear on the wheel with a spring loaded cam for rotation which may allow for proper engagement of the cam along the tangential ribs of the wheel.

### CROSS REFERENCE TO RELATED APPLICATION

This application claims priority from U.S. Provisional Patent Application Ser. No. 61/084,490 filed Jul. 29, 2008, which is hereby incorporated herein by reference in its entirety.

### BACKGROUND

Generally, ratchets include a gearwheel or linear rack with teeth, and a pawl. The pawl may be a spring-loaded pivoting mechanism that interacts with the teeth of the gearwheel to permit motion, linear or rotation, in one direction while preventing the opposite motion. The teeth or the pawl may be curved so that the pawl may slide up and over each tooth in turn, while the spring forces the pawl back into the depression of the next tooth permitting smooth motion in one direction. However, when the gearwheel is moved in the opposite direction, the angle of the pawl causes it is to catch against a tooth and prevents further motion.

Generally, ratchets are used with cords, such a rope, metallic cables, etc., that wrap around a spool. The spool may be integrated with the gearwheel, and therefore include teeth located circumferentially around the edge of the spool. The teeth then interact with the pawl to permit rotation in one direction to tighten the cord and prevent rotation in the other direction. The pawl may include a thumb release to permit selective rotation of the spool in either direction. A hook or other securing member may also be included to anchor the ratchet.

Known ratchets include many parts, including the ratcheting function parts, the supporting structure parts of the spool, the thumb release parts, and the hook. Additional parts increase the time and costs attendant with manufacturing and assembling each ratchet. Alternatively, the operating surfaces of the cord engaging spool usually abrade and destructively compress the cord resulting in reduced tensile strength and possible catastrophic failure of the cord after a short period of use. The armature supporting the spool is also generally a relatively small diameter that imposes significant forces per unit area of the supporting housing and results in a likelihood of catastrophic failure.

### SUMMARY OF THE INVENTION

The present invention relates to an apparatus and a system for improving rope tie downs. The apparatus includes a new design whereby the apparatus has a thick walled nylon, aluminum and/or stainless steel body, with a tangential rib opposing the face wheel. The apparatus may have a gear on the wheel with a spring loaded cam for rotation which may allow for proper engagement of the cam along the tangential ribs of the wheel.

To this end, in an exemplary embodiment of the present invention, an apparatus and a system for a rope tie down apparatus is provided.

An exemplary embodiment of the present invention is to provide a ratchet for use with a cord, the ratchet comprising: a first and second body rotatable coupled to one another to form a housing, wherein the first body can swing with respect to the second body to permit access to an interior of the housing; and a wheel, coupled to the housing, having first and second sections that have interior faces forming a cavity to support the cord.

In another exemplary embodiment, comprising an opening in the housing to permit the cord to enter and exit the interior of the housing, wherein the opening is smaller than a diameter of the wheel.

In another exemplary embodiment, wherein the housing is secured in a closed position by a push button.

In another exemplary embodiment, wherein the housing is secured in a closed position by bearing lock pins.

In another exemplary embodiment, comprising at least one pulley coupled to housing at a cord access hole in the housing to reduce frictional wear on the cord from rubbing against the housing.

In another exemplary embodiment, comprising at least one pulley coupled to housing and positions to keep the cord in contact with more than half of a circumference of the wheel.

In another exemplary embodiment, wherein the interior face of the first section has a plurality of first ribs and the interior face of the second section has a plurality of second ribs to grip the cord, wherein the plurality of first and second ribs project into the cavity between the first and second sections.

In another exemplary embodiment, wherein the plurality of first and second ribs extend generally from a center of the first and second sections to an edge of the first and second sections.

In another exemplary embodiment, wherein the plurality of first and second ribs are flared.

In another exemplary embodiment, wherein the plurality of first and second ribs are rectilinear.

In another exemplary embodiment, wherein the plurality of first and second ribs are non-radial.

In another exemplary embodiment, wherein the plurality of first and second ribs are non-radial, rectilinear, and flared.

In another exemplary embodiment, wherein the plurality of first and second ribs form a generally V-shaped profile within the cavity between the first and second sections.

In another exemplary embodiment, wherein the interior faces of the first and second sections are textured to further grip the cord.

In another exemplary embodiment, further comprising a cam coupled to the housing to reduce slipping between the cord and wheel.

In another exemplary embodiment, wherein the cam is spring loaded to permit the cam to rotate away from the wheel.

In another exemplary embodiment, wherein the cam is spring loaded to permit the cam to slide away from the wheel.

In another exemplary embodiment, wherein the cam is rotatable coupled to housing, wherein an axis of rotation of the cam is off centered.

In another exemplary embodiment, wherein the cam is configured to permit the wheel to rotate in one direction and permit the cord to easily pass, but grip the cord when the wheel rotates in an opposite direction.

In another exemplary embodiment, further comprising a pawl coupled to the housing, wherein the pawl permits the wheel to rotate in one direction but prevents rotation in a reverse direction.

In another exemplary embodiment, wherein the pawl includes at least two teeth to interferingly engage a set of teeth on the wheel to prevent the rotation in the reverse direction.

In another exemplary embodiment, further comprising a shoulder in the housing to support a notch in the pawl when the ratchet is support weight and the pawl is preventing the rotation in the reverse direction.

In another exemplary embodiment, wherein the pawl includes a thumb release for selectively limiting rotation of the wheel.

In another exemplary embodiment, further comprising a handle coupled to the housing.

In another exemplary embodiment, an apparatus and a system for a rope tie down apparatus may be provided whereby the apparatus may be constructed of aluminum.

Another exemplary embodiment is an apparatus and a system for a rope tie down apparatus whereby the apparatus may be constructed of stainless steel.

Yet another exemplary embodiment of the present invention is to provide an apparatus and a system for a rope tie down apparatus whereby the apparatus may be constructed of nylon.

Still another exemplary embodiment of the present invention is to provide an apparatus and a system for a rope tie down apparatus whereby the apparatus may be constructed of G10 material.

An exemplary embodiment of the present invention is to provide an apparatus and a system for a rope tie down apparatus whereby the apparatus may be constructed of any suitable rigid material.

Yet another exemplary embodiment of the present invention is to provide an apparatus and a system for a rope tie down apparatus whereby the apparatus is able to support large weight capacities with fewer mechanical parts.

Another exemplary embodiment of the present invention is to an apparatus and a system for a rope tie down apparatus may have a fixed housing access for a rope.

Still another exemplary embodiment of the present invention is to provide an apparatus and a system for a rope tie down apparatus whereby the apparatus may have a swing able housing for rope access.

Yet another exemplary embodiment of the present invention is to an apparatus and a system for a rope tie down apparatus whereby the apparatus may have a spring loaded button on the wheel.

Still another exemplary embodiment of the present invention is to provide an apparatus and a system for a rope tie down apparatus whereby the apparatus may have a spring loaded button on the cam to release the housing.

Another exemplary embodiment of the present invention is to provide an apparatus and a system for a rope tie down apparatus whereby the apparatus may have a spring loaded button to release the housing allowing the housing to swing freely, to an open position and easily close and lock.

An exemplary embodiment of the present invention is to provide an apparatus and a system for a rope tie down apparatus whereby the apparatus may be easier to use than prior art applications.

Still another exemplary embodiment of the present invention is to provide an apparatus and a system for a rope tie down apparatus whereby the apparatus may be easier to use and may have higher weight capacities than prior art applications.

Yet another exemplary embodiment of the present invention is to provide an apparatus and a system for a rope tie down apparatus whereby the apparatus may have a secondary tooth design to add to a wedging against the housing screw shoulder for additional support.

Still another exemplary embodiment of the present invention is to provide an apparatus and a system for a rope tie down apparatus whereby the apparatus may have a “V” notch for additional support and to stop the breaking of the gear or tip of the pawl.

Another exemplary embodiment of the present invention is to an apparatus and a system for a rope tie down apparatus whereby the apparatus may have a wheel with opposing face ribs.

Yet another exemplary embodiment of the present invention is to an apparatus and a system for a rope tie down apparatus may have a plurality of ribs whereby the ribs flare out at the end of each rib to increase holding capacities.

Still another exemplary embodiment of the present invention is to provide an apparatus and a system for a rope tie down apparatus whereby the apparatus may have at least one tangential rib.

Another exemplary embodiment of the present invention is to provide an apparatus and a system for a rope tie down apparatus whereby the apparatus may have a wheel whereby the wheel may have a pattern of puzzles, ridges, ribs, spikes, knurled or starts to aid in gripping the rope with the cam under tension.

Yet another exemplary embodiment of the present invention is to provide an apparatus and a system for a rope tie down apparatus whereby the apparatus may have a handle.

Still another exemplary embodiment of the present invention is to provide an apparatus and a system for a rope tie down apparatus whereby the apparatus may have a plurality of handles for rotating the wheel or a gear with a cam.

Still another exemplary embodiment of the present invention is to provide an apparatus and a system for a rope tie down apparatus whereby the apparatus may have a plurality of handles for rotating the wheel or the fear with a cam, whereby the handles are mounted inside the housing and a handle mounted outside the housing may attach to the axis of the wheel.

In another exemplary embodiment of the present invention is to provide a ratchet having a mold formed primarily of plastic elements.

Yet another exemplary embodiment of the present invention is to provide an apparatus and a system for a rope tie down apparatus, whereby the apparatus may be non-corrosive having a minimal amount of parts.

In yet another exemplary embodiment of the present invention is to provide an apparatus and a system for a rope tie down apparatus, whereby the apparatus may have a minimal amount of parts thereby reducing manufacturing and assembly costs.

Another exemplary embodiment of the present invention is to provide an apparatus and a system for a rope tie down apparatus whereby the apparatus may be usable in harsh environments without fear of deterioration.

Still another exemplary embodiment of the present invention is to provide an apparatus and a system for a rope tie down apparatus whereby the apparatus is to assemble by sonic welding.

Yet another exemplary embodiment of the present invention is to provide an apparatus and a system for a rope tie down apparatus whereby the apparatus may have a spool for a ratchet, which spool has a large diameter supporting journal to reduce the load density of forces imposed.

A further exemplary embodiment of the present invention is to provide an apparatus and a system for a rope tie down apparatus whereby the apparatus may have a spool for a ratchet having a pair of wheels mechanically aligned and welded with one another to ensure their positional relationship.

Various objects, features, aspects and advantages of the present invention will become more apparent from the following detailed description of preferred embodiments of the invention, along with the accompanying drawings in which like numerals represent like components.

Additional features and advantages of the present invention are described herein, and will be apparent from the detailed description of the presently preferred embodiments and from the drawings.

### BRIEF DESCRIPTION OF THE DRAWINGS

FIG. 1A illustrates a ratchet assembly according to embodiments of the present invention, including the housing.

FIG. 2A-2B illustrates a ratchet assembly according to embodiments of the present invention, including an alternate embodiment of the housing.

FIG. 3A-3C illustrates a ratchet assembly according to embodiments of the present invention, including an alternate embodiment of the housing.

FIG. 4 illustrates a ratchet assembly according to embodiments of the present invention, including an alternate embodiment of the housing.

FIG. 5A-5E illustrates a ratchet assembly according to embodiments of the presenting invention, including a pawl.

FIG. 6A-6D illustrates a representative pawl according to embodiments of the present invention.

FIG. 7 illustrates a blown up view of the ratchet assembly according to embodiments of the invention.

FIG. 8A-8D illustrates a representative wheel, according to embodiments of the invention.

FIG. 9A-9E illustrates a representative cam, according to embodiments of the invention.

FIG. 10A-10E illustrates a ratchet assembly according to embodiments of the present invention, including the cam.

FIG. 11A-11B illustrates a ratchet assembly according to embodiments of the present invention, including a handle.

FIG. 12A-12B illustrates a ratchet assembly according to embodiments of the present invention, including an alternate embodiment of the handle.

FIG. 13A-13C illustrates a ratchet assembly according to embodiments of the present invention, including an alternate embodiment of the handle.

FIG. 14A-14B illustrates a ratchet assembly according to embodiments of the present invention, including an alternate embodiment of the handle.

FIG. 15A-15D illustrates a ratchet assembly according to embodiments of the present invention, including a handle and pulley system.

FIG. 16 illustrates a ratchet assembly according to embodiments of the present invention, including a disengage bar.

FIG. 17 illustrates a ratchet assembly according to embodiments of the present invention, including a pulley.

FIG. 18 illustrates a ratchet assembly according to embodiments of the present invention, including an alternate embodiment of the pulley.

FIG. 19 illustrates a ratchet assembly according to embodiments of the present invention, including a come along.

### DETAILED DESCRIPTION

In the following description of preferred embodiments, reference is made to the accompanying drawings which form a part hereof, and in which it is shown by way of illustration specific embodiments in which the invention can be practiced. It is to be understood that other embodiments can be used and structural changes can be made without departing from the scope of the embodiments of this invention.

Generally, ratchet assembly includes housing 1H, enclosing a wheel 1W, one or more pawls 5P, and one or more cams 9C. Wheel 1W supports a cord and provides easy rotation of the cord. Wheel 1W generally includes a gear with teeth that engagingly interacts with pawl 5P to permit smooth rotation in one direction, but catches to prevent the opposite rotation. Cam 9C applies pressure on the cord against the wheel 8W, and may include additional gripping features to increase the friction against the cord and reduce slipping. The pawl 5P and cam 9C may be separate components or combined, integrated, or coupled together. Ratchet assembly may further include one or more pulleys 17P to assist in directing the cord and reduce cord wear through rubbing against the housing. Alternately or in combination, a disengage bar 16D may further direct the cord out of housing 1H. A come along 19C may also be included to support the incoming cord weight and provide easier rotation of wheel 8W. To provide further tension on the cord, a handle 11H may be coupled to rotate wheel 8W. An alternate handle may be used including a cam 9C to provide an additional locking mechanism. Housing 1H, wheel 8W, pawl 5P, cam 9C, pulley 17P, disengaging bar 16D, come along 19C, and handle 11H are used generally to refer to the various components according to embodiments described herein. The embodiments of these components may be used singularly or in combination.

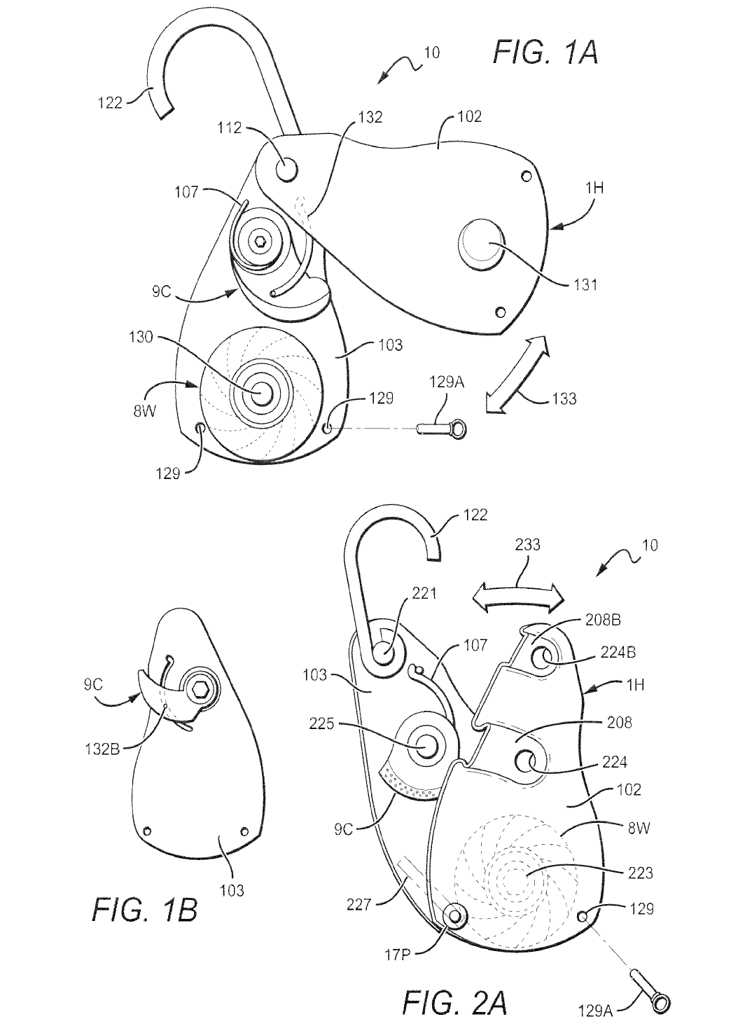

Housing 1H, illustrated in various embodiments in FIGS. 1-4, may be opened by rotating one body part with respect to another to permit easy access to the interior of the housing for loading. The housing 1H may rotate about the axis of one of the housing corners, the hook, or the wheel. Housing 1H may include various locking mechanisms to ensure the housing stays closed during use, such as push button lock, bearing locking pins, detents, etc.

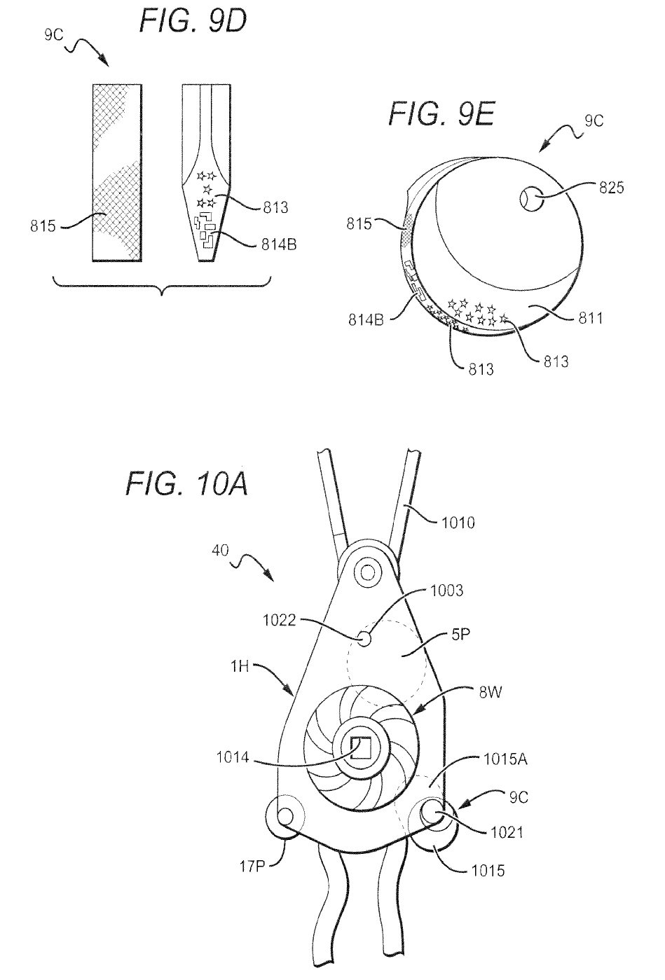

Wheel 8W, illustrated in FIG. 8, supports the cord and is generally permitted to rotate in only a single direction, thereby holding tension on a line. Wheel 8W may be coupled to housing 1H through a bearing race surface to permit easy rotation. Wheel 8W includes interior facing sides to contact cord with surface features to grip the cord. The interior facing sides may include ribs that generally flare as they approach the outside perimeter of the wheel. The cross section of the interior space may be generally V or U shaped to grip the cord as it is pushed against the wheel by cam 9C.

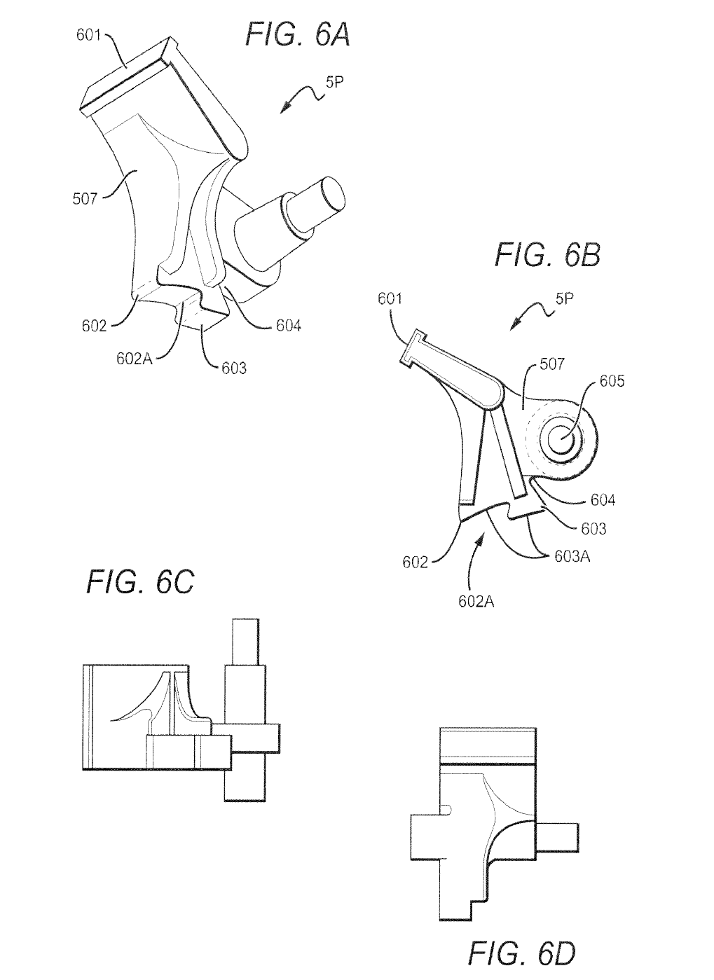

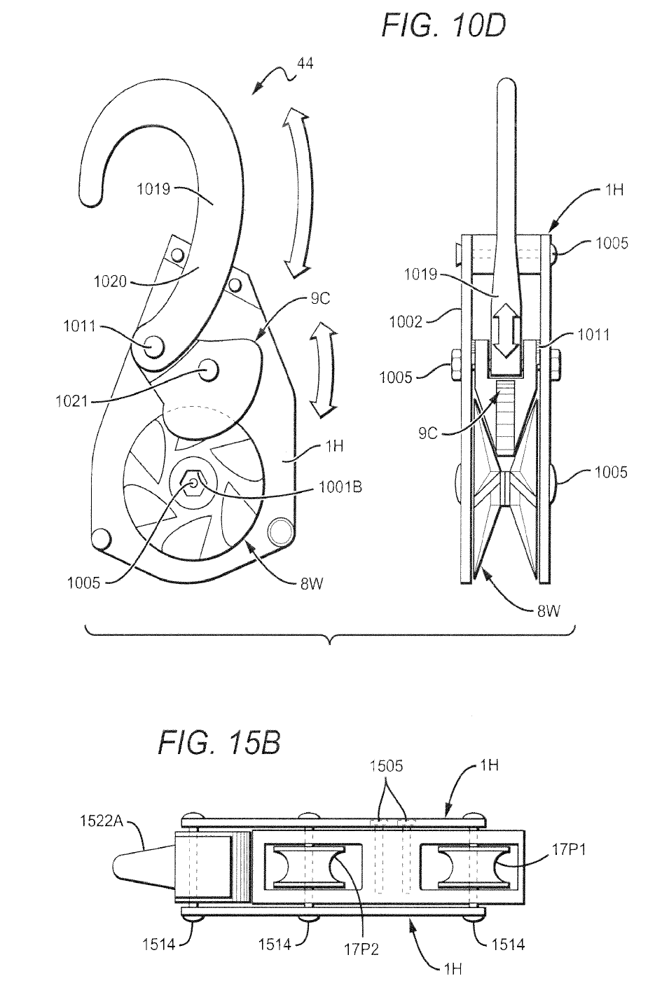

Pawl 5P, illustrated in FIGS. 5-7, engages the teeth of the wheel gear to permit easy motion in one direction while preventing the opposite motion. The pawl 5P includes a double tooth design to increase the support surface area and thereby increase the load weight. The pawl 5P may also include a V-notch behind the teeth to further support the pawl 5P, which rests against a corresponding shoulder of housing 1H. Pawl 5P may also include a release mechanism to permit Cam 9C, various embodiments illustrated in FIG. 10, may be included to provide additional pressure against the cord and increase the grip between the wheel and cord. The cam 9C may be used as an additional safety stop, holding the cord in tension. The cam surface may be textured to increase the grip between the cord and cam. The outside edge of the cam, in contact with the cord, may be shaped in a U or V shape. The U shape may be an indention into the edge of the cam to create a half void space when in position against the wheel. The V shape may be an outward extension of the outer edge of cam to correspond with the interior of the wheel profile. The cam's outer edges may also be tapered. The cam may be spring loaded to provide additional pressure against the cord and wheel, but may be moved by a handle or thumb release to permit easy access between the cam and wheel to load the assembly.

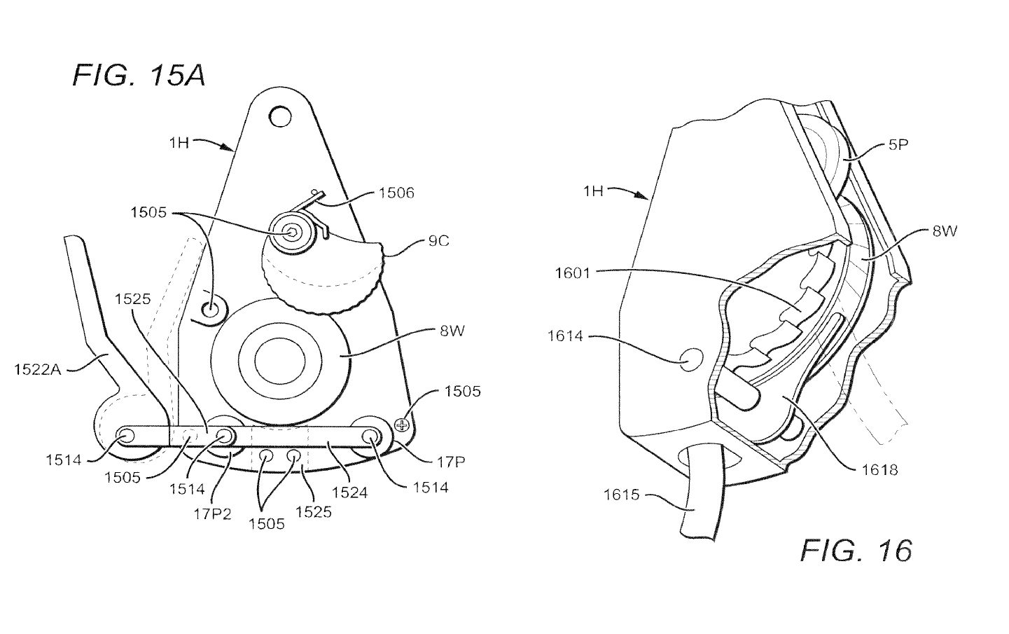

Pulleys 17P, various embodiments illustrated in FIGS. 17-19, may be included to direct the cord to increase the potential gripping surface between cord and wheel 8W. Pulleys 17P also provide a smooth rotation surface for cord as it passes through housing 1H, reducing wear through rubbing against the housing. Pulleys 17P may be spring loaded to further provide access to wheel 8W during loading, or may provide an additional safety stop mechanism when the cord is under tension. Pulley 17P may be used to further support the incoming side of the cord to provide easier rotation of wheel 8W.

Although embodiments of the invention may be described and illustrated herein in terms of separate components, it should be understood that embodiments of this invention are not so limited, but may be used in various combinations for the desired application. Furthermore, although embodiments of the invention may be described and illustrated herein in terms of a ratcheting pulley assembly, it should be understood that embodiments of the invention are also applicable to other applications including general ratcheting systems, such as clocks, capstans, turnstiles, spanners, winders, cable ties, jacks, hoists, etc. Embodiments of the various components may be combined to reduce the total components, such as, the cam and pawl integrated into single part.

FIGS. 1-4 illustrate exemplary ratchet pulley assemblies 10 according to embodiments of the invention representing various alternate embodiments of the housing assembly 1H. As seen in FIG. 1, the housing 1H of the ratchet 10 may be essentially pear shaped to provide a lateral balance from the point of suspension of the ratchet from the hook 122. The body may alternatively be substantially triangular, tear-drop shaped, or any combination therebetween. In order to secure the cord with the ratchet, the terminal end of the cord is inserted through the bottom opening on the left side of the wheel 8W. The wall of the interior of the housing 1H may be curved to form a cavity within which the wheel is housed. The housing may include openings to enhance insertion of the cord by permitting manual rotation of the wheel in the clockwise direction. The terminal end of the cord is brought out from within the housing through the bottom opening.

However, in another exemplary embodiment, instead of feeding the cord through the opening in the bottom of the ratchet, housing is in multiple parts that may be opened, permitting direct access to the interior of housing 1II to load the cord around wheel 8W. The housing may include locking mechanisms to secure the housing while in use. The locking mechanisms may be disengaged to permit the housing parts to rotate relative to each other. For example, one or more lock pins, or a spring loaded button on the spool or cam may be used separately or in conjunction to allow the housing the spool to swing freely, to an open position which allows for the cord to be threaded therethrough and may be easily closed and locked when not in use. The use of the lock pins allows for easier use of the ratchet along with stronger capabilities of same.

Generally, ratchet pulley assembly 10 has a housing 1H,which includes two pieces, a front housing 102 and a back housing 103. A wheel 1W may be rotatably coupled to the back housing 103, which may support and accommodate a cord (not shown). Also coupled to the housing 1H may be a cam 9C and/or pawl 5P through a spring 107, which is held in place by screws 106. The components, wheel, cam, and pawl, may be coupled to housing 1H generally by any devices known in the art, such as screws, rivets, snap fits, etc. In one embodiment, a hook 122 may extend from the upper end of the housing 1H to secure the ratchet to an anchor, or the like.

The housing may also be fixed, or swingable to simplify the access to the cord. A button on the wheel or cam may be used to release the housing allowing it to swing freely, to an open position and easily closed and locked. Pins, screws, or shoulder rivets may be used to assembly the housing in a fixed or swingable position.

The bottom of the ratchet assembly 10 may include one or more openings (not shown). The cord may be partially wrapped about the wheel 1W with a first end and a second end exiting through the same or different openings. In a preferred embodiment, the length of the opening is smaller than the diameter of the wheel 1W such that the cord is urged radially inward about the wheel 1W. Therefore, when a force is applied to the cord on either end of the cord, a greater length of the cord will stay in contact with the wheel to mechanically engage the cord with the wheel and reduce slippage. Housing 1H may also include housing supports or pulleys, described in further detail later, to additionally direct the cord path.

FIG. 1 illustrates one embodiment of the housing assembly. FIG. 1A is a front view of the ratchet pulley assembly 10, where the front housing 102 swings away from the back housing 103 to permit access to the interior of the ratchet body, as indicated by arrow 133. FIG. 1B illustrates a profile view of the same assembly. The front housing 102 may swing about rivet 112, which couples the front housing 102 to the back housing 103 and the hook 122. Therefore, instead of feeding the cord through a bottom opening in the housing 1H to wrap around the wheel 8W and back out of the housing, the front housing 102 may be swung open to permit direct access to the wheel 8W. Rivet 112 may be a ball bearing spring pin. Alternatively, the body 103 may include a rod, which may be coupled to housing 103 or integrally formed with the housing.

The housing 102 and 103 may include one or more pull lock pins at the bottom of the wheel 8W. By pulling the locking pins, the front housing 102 may release from the back housing 103 to permit rotation. In one embodiment, the back housing 103 and front housing 102 may include one or more bearing locking pin holes 129. In FIG. 1A, two bearing locking pin holes 129 are shown at the bottom of ratchet body 102 and 103 on either side of wheel 8W. A locking pin 129A may then be used with these pin holes 129 to secure the front housing 102 to the back housing 103 to prevent relative motion during use.

The wheel 8W may additionally include a push button 130 to permit the wheel to release from housing 102. The front housing 102 may also include a curved plate surface 131 to allow the push button wheel 130 to engage and disengage. As seen in FIG. 1B the push button 130 may extend exterior of front housing panel 102. The front housing 102 may be held in place, preventing rotation relative to the back housing 103 by this push button. The push button 130 may then be depressed to permit the front housing 102 to slide past the wheel 8W and open the housing, exposing its interior. The front panel 102 may include a curved surface 131 that covers the push button 130 when the housing is closed. The curved surface 131 of the front panel 102 may be of a flexible material to permit depression and therefore disengage the push button 130 from housing 102. The push button 130 and wheel 8W may be coupled to the back housing 103 by screw 112, or rivet, or other means known in the art.

As seen in FIG. 1A, the cam 9C may move outside the perimeter of the back housing 103. This permits easier loading of the cord when the front housing 102 is open; the cam 9C may be rotated outside of the housing 103 perimeter, thereby increasing the space between the cam 9C and the wheel 8W. A cord may then be easily loaded into the ratchet before the assembly 10 is closed, by returning the cam 9C against the wheel 8W and closing the front panel 102. The back housing 103 may also include a thumb release 132 to permit the cam 9C to move outside of the back housing 103 when the front housing 102 is open. The thumb release 132 may be used to easily release and rotate the cam to a desired loading or engaged positions. Thumb release 132 is coupled to cam 9C by pin 132B. Pin 132B is permitted to slide along groove 132A in housing 103 to rotate cam 9C to the desired position. Spring 107 may be coupled to cam 9C to bias cam against wheel 8W when engaged.

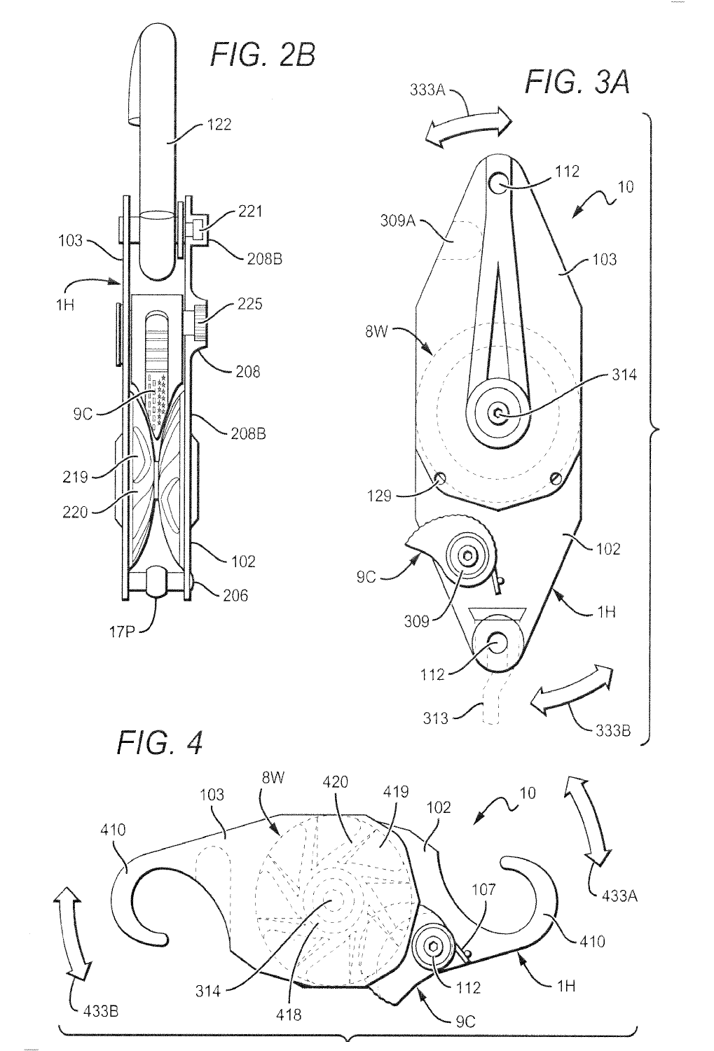

FIG. 2A illustrates a side view, while FIG. 2B illustrates a profile view of alternate embodiments of the ratchet pulley assembly 10 according to embodiments of the invention, including alternate embodiments of the housing 1H. The ratchet assembly 10 includes a front body 102 and back body 103. Front body panel 102 may swing in direction of arrow 233, rotating about the lower corner of the ratchet assembly 10, as opposed to the hook connection at the top of the assembly. Again the housing may include a locking mechanism, which may include a push pin, detachable pin, screw, detent with mated contours for a friction fit, etc., to prevent the housing from opening during use. As seen in FIG. 2, a locking pin 129A with bearing is used with bearing locking pin hole 129.

In one embodiment, a locking mechanism may be included. For example, a push button 225 coupled to cam 9C mount or push button 221 coupled to hook 122 mount may engage housing 102 and prevent rotation during use. To permit easy release of the front housing 102, the front housing may include a lock hole 224 for a push button release 225 in the cam 9C to lock the housing 102 with 103. The front housing 102 may also include a locking track 208 from the lock hole 224 to the edge of the housing 102 to permit easier release of the bush button 225. Locking track 208 may couple with push button 225 by a head that fits the groove opposite the housing to lock the front panel 102 with the back housing 103. In another embodiment, a housing hook pin 221 is included with a wash head to latch in the front housing 102. The front housing 102 may include an additional lock hole 224B with housing track 208B. The housing hook pin 221 may latch in the track 208B or hole 224B or may lock with a ball bearing spring loaded connection with the hole 224B.

The locking mechanisms described above, including the push button for the cam 225 with lock hole for push button release 224, and housing hook pin 221 with lock hole 224B may be used in conjunction to ensure the front housing 102 is securely locked to the back housing 103 during use. These locking mechanisms may alternatively be used independently so the housing is coupled together by either the push button 225 on the cam 9C or the housing hook pin with latch 221 to secure the front housing 102 to the back housing 103. Alternatively, a hex 223 on wheel 8W may alternatively be used to secure the front housing 102 with the back housing 103, and may be used to rotate wheel 8W to increase tension in cord (not shown).

The ratchet pulley system 10 may also include a pulley 17P. The pulley may be the joint where the front housing 102 pivots to swing away from the back housing 103. The pulley may be coupled to the front 102 and back housing 103 in any manner that permits the front housing to rotate about the pulley. As seen in FIG. 2B, the pulley 17P is coupled to the housing by a screw 206. The housing also may include a slide hole 227 for the pulley to permit additional flexibility in loading the ratchet and access to the interior.

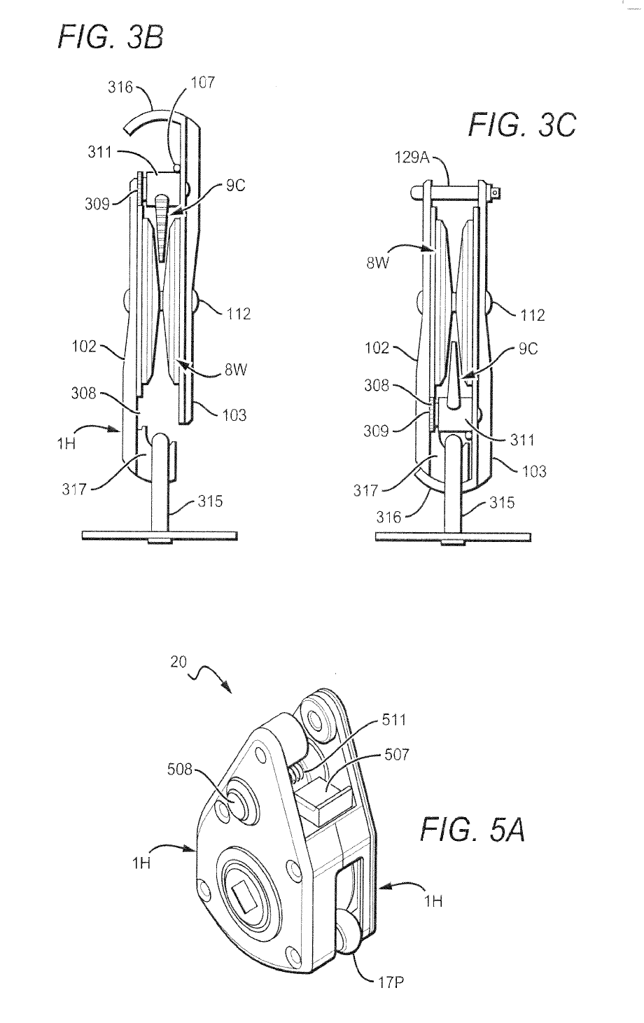

FIG. 3A-3C illustrates a representative alternate embodiment of the ratchet body 1H according to aspects of the invention. FIG. 3A illustrates a side view of a ratchet pulley assembly 10 according to aspects of the invention including alternate housing embodiments. Front housing 102 may move with respect to back housing 103 as indicated by arrows 333A and 333B, rotating about the center of wheel 8W. Wheel 8W is coupled to housing 102 with a screw or bolt 314, as seen in FIG. 3A, or with a rivet 112, as seen in FIG. 3B. Cam 9C may be attached with a pin 309 that includes a head designed to fit in indention 309A on the back housing 103 to lock the housings 102 and 103 together. The housing may include two rivets 112, one on each housing 102 and 103. The rivets 112 may be used to couple hook 313 to the housing and anchor the ratchet system. When the housing is closed, the two holes for rivet 112 may align to support hook 313.

FIGS. 3B and 3C illustrate representative profile views of ratchet assembly 10 of FIG. 3A, where FIG. 3B illustrates the ratchet assembly in an open position and FIG. 3C illustrates the ratchet assembly in a closed position. Cam 9C is coupled to housing 103 by a lock pin 311 including a pin 309 with head to fit a groove 308 in the opposite housing 102 to lock the housing together. Housing 102 includes a hook or main weight carrying area to support hook point 315. When the housing is closed, housing support cover 316 of back housing 103 is adjacent to the main support 317. Each housing 102 and 103 may include a locking mechanism to secure the front housing 102 with the back housing 103 when in the closed position. For example, housings 102 and 103 may include bearing locking pin holes 129 to engage locking pin 129A.

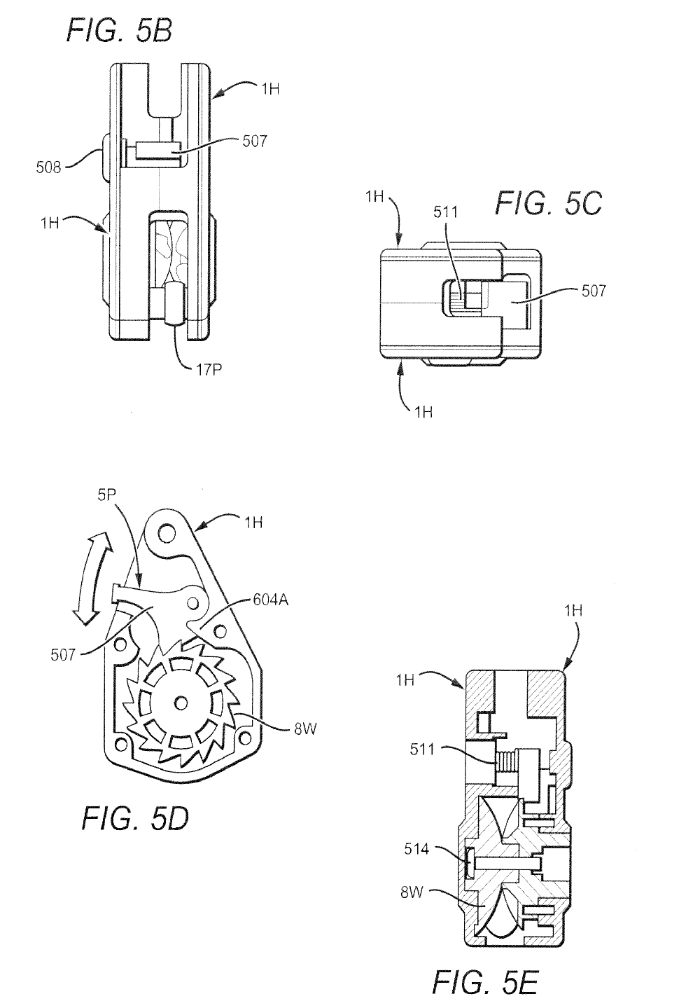

FIG. 4 illustrates a representative ratchet pulley assembly 10 according to aspects of the invention including alternative embodiments of the housing 1H. FIG. 4 is similar to the embodiment of FIG. 3 in that the two housing sections 102 and 103 may rotate relative to each other about the center of wheel 8W as indicated by arrows 433A and 433B. Housing 102 and 103 includes hooks 410 integrally formed with the housing.

The housing may be constructed of moldable plastic material. However, it should be understood that the housing may be constructed of any suitably rigid material which may be able to withstand sufficient loads imposed thereon. Other suitable materials may include nylon, delrin, or any of the other known or to be developed plastic materials having high strength characteristics. In one embodiment, the housing is a carbon fiber glass filled nylon. Preferably, the housing is approximately, and particularly is approximately 43% carbon fiber glass filled nylon. The housing may alternatively be fabricated from aluminum, stainless steel, nylon, G10 material. The desired component materials need not necessarily be the same, but may be chosen to add to the structural support of the unit, providing the design with greater weight capacities with fewer parts. The housing may be coupled together through any coupling methods known in the art, such as, welding, gluing, rivets, detent, screws, snaps, or any combination thereof

FIGS. 5A-7 illustrate representative ratchet assembly 20 including pawl 5P according to various embodiments of the invention. Pawl 5P is generally used to engage with teeth on wheel 8W and permit rotation in a single direction. Pawl 5P includes a double tooth design to increase the surface contact to reduce the stress on the pawl when supporting a load in a locked position. The pawl 5P may also include a wedge to rest against a shoulder of housing 1H to further support the pawl. Pawl 5P may be spring loaded, where the pawl is biased to an engaged position with wheel 8W, but may be removed to permit the wheel to rotate freely.

FIG. 5A-5E illustrates a representative ratchet pulley assembly 20 according to embodiments of the invention, including the pawl 5P or trigger. FIG. 5A is a perspective view of the ratchet pulley assembly 20, FIG. 5B is a side view, FIG. 5C is a top view looking down at the pawl, and FIGS. 5D and 5E are cut away views from perpendicular angles, where FIG. 5D is an open sided view with pawl trigger, and FIG. 5E is cut in half.

Ratchet pulley assembly 20 includes housing 1H, as previously described. Pawl 507 interacts with wheel 509 to permit motion in only one direction. Spring 511 is used to bias the pawl 507 against the wheel 8W. A push button release 508 may be included to release the pawl 507 from the wheel 8W to permit rotation in either direction. Pulley 17P may also be included.

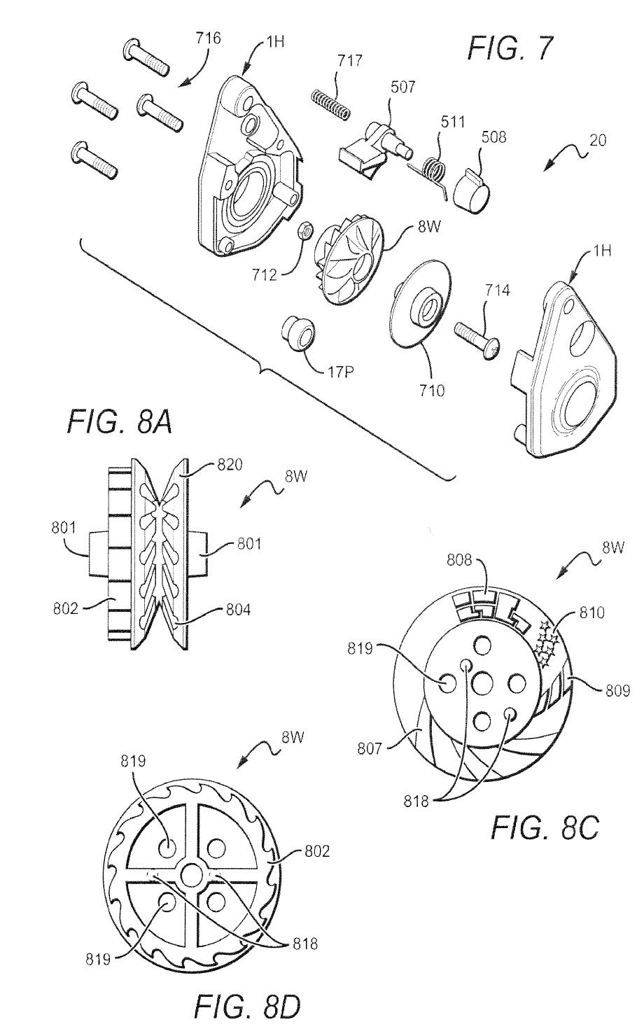

FIG. 6A-6D illustrates a representative pawl 5P, as seen in FIG. 5D. FIG. 6A is a perspective view, FIG. 6B is a side view, FIG. 6C is a top view, and FIG. 6D is a front view. Pawl 507 includes a thumb or finger engagement surface 601. Pawl 507 also includes a secondary tooth design 602A and a V-notch 604. Teeth 602 and 603 engage with corresponding structures on wheel 8W to permit the wheel to freely rotate in one direction, but catch, preventing rotation in an opposite direction. The teeth may be curved on a bottom side 603A, similar to a wave form, to reduce resistance with the wheel 8W as the teeth slide over ribs of the wheel. Two teeth 602 and 603 increase the surface holding to wheel, preventing the wheel from rotating backwards, therefore, increasing the potential load of the device. V-notch 604 wedges against corresponding housing shoulder 604A. The wedging against the housing shoulder supports the pawl and reduces the potential to break off the gear or tip of the pawl. Therefore, preventing this from being a weak point in the product. The load limit of the assembly may be increased to about 760 pounds from a 400 to 500 pound maximum.

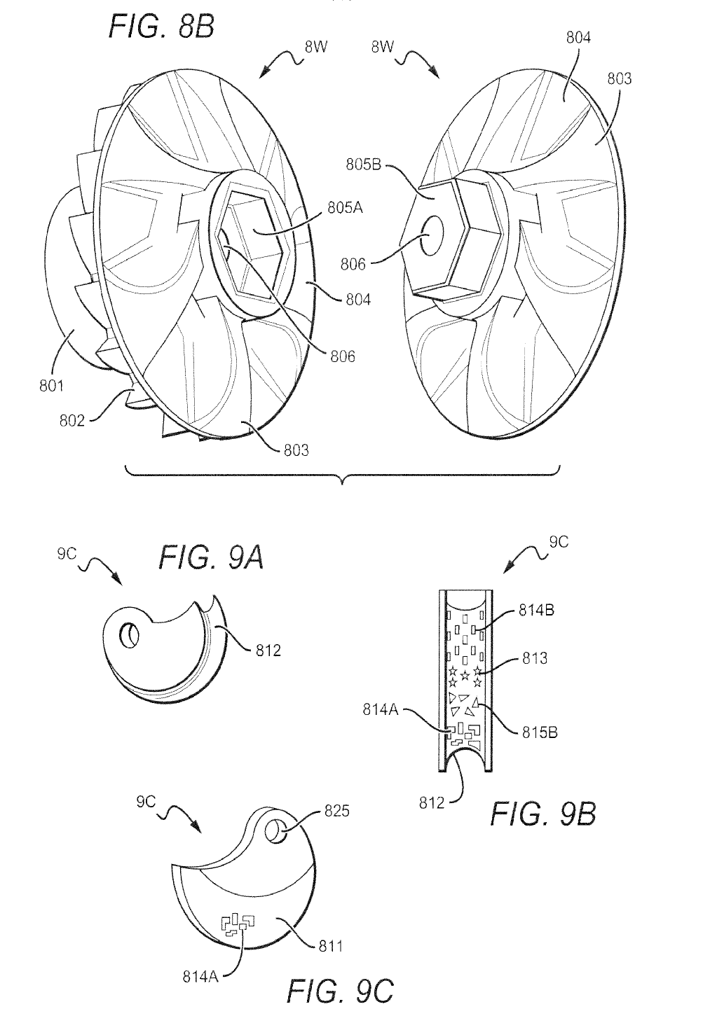

FIG. 7 is a blown apart view of the ratchet pulley assembly of FIG. 5. Housing 1H is in two parts, coupled together by screws 716, enclosing the rest of the components. Ratchet 20 may include pulley 17P coupled between the housing 1H panels. Pawl 507 is biased against wheel 8W by a spring 511. A release push button 508 may be coupled to pawl 507 to release the pawl 507 from the wheel 8W. The release button 508 is biased with spring 717. Wheel 8W may be coupled to the housing 1H by screw 714 and nut 712 along with wheel grip plate 710.

FIG. 8A-8D illustrates a representative wheel 8W according to embodiments of the invention. FIG. 8A is a profile of wheel 8W illustrating the interior of the wheel surface 804. Wheel 8W includes a bearing 801 or race surface on either side of the wheel 30. The bearing 801 is adjacent to a gear 802 on one side of the wheel 8W. The interior facing sides of the wheel 8W includes a wheel surface 804 configured to grip the cord. Along the perimeter of the wheel interior is a wheel edge support 820.

FIG. 8B illustrates a perspective view of the two parts of the wheel 8W according to aspects of the invention, separated from each other. The wheel surface 804 on both sides of the wheel are the interior adjacent faces of the wheel 8W. On the wheel surface 804 are ribs 803 to better grip a cord and prevent slippage during use. On the exterior facing sides of wheel are bearings 801. Adjacent to the bearing 801 and on the backside of the wheel surface 804 on one face is a gear 802. The gear 802 includes teeth to engage the pawl 5P and limit motion to a single rotational direction. Through the center of the wheel 8W is a screw hole 806 to couple the wheel 8W parts together and to the ratchet housing 1H. At the center of the wheel surface 804, axially aligned and centered with the screw hole 806, are corresponding hex key 805. Represented as a hex key 805, this surface can be any compatible surface to reduce slippage between the wheel parts. As illustrated, one face includes a hex key 805A that is sunken into the piece, while the other face include a corresponding hex key 805B emerging from the piece to couple with the adjacent face and form a friction fit.

The ribs 803 may flare out at the end of the rib toward the periphery of the wheel surface 804, which forces the cord to engage the opposite face. The additional grip provided by the rib flare increases the wheel hold capacity by approximately 280 pounds. The ribs 803 may include a profile projecting into the interior space between opposing faces 804. This profile may be generally V-shaped, where the rib projections 803 are greater near the center of the wheel than at the edges. As discussed later, cam 9C, may include a corresponding V-contour to fit within the wheel interior. Rib interior profile may alternatively be U-shaped with an inverted corresponding pawl shape, so when the two come together they form an ovoid or circular cross section for the cord, just under the cord diameter.

In the pieced wheel design, the cam support prevents the wheel from separating, extending the longevity of the device.

An alternate embodiment may include a unitary wheel design. In this embodiment, the wheel is an extrusion of a single piece solid heavy duty material. The flared rib concept may be combined with extruded abilities to form the same tangential rib in a one piece wheel. The bosses of the wheel may additionally pressed into close ball bearings for smoother rotation when they are pressed into the hub of the housing. A unitary wheel provides extra strength when the wheel is under pressure since separation in the V groove, where the cord forces down between the wheel, is eliminated. To improve carrying weight load, wheel 8W may be a solid based wheel with a sealed bearing and press in pin for a smoother rotation. The wheel may include a V shaped or a light U cut into the center to hold the rope in place under rotation and a V face wheel with the same width as the cam for a solid surface grip without crushing the rope.

FIG. 8C illustrates a surface of wheel 8W including various patterns to aid in gripping the cord when the cam 9C is under tension. These surface features may be used in combination or alone to increase the gripping effect of the wheel. For example, the surface of the wheel may have a pattern of puzzles 808, ridges, ribs or tangs 807, step tangs 809, spikes, knurls, or stars 810, or other raised or gripping surface.

FIG. 8D is a side view of the wheel 8W looking toward gear 802. Gear 802 includes teeth to engage the pawl 5P to permit easy rotation in one direction, but to interfere and prevent rotation in the opposite direction. The teeth may be in a wavelike pattern where one side is curved to permit the corresponding teeth of the pawl, as seen in FIG. 6, to easily slide over the gear surface. The adjacent tooth face may also be curved so that there is an overhang to provide a better interference surface to engage the teeth of the pawl. The wheel 8W may include holes 819 for screws to help support the wheel flex. Four holes are illustrated in FIG. 8C but any number may be used to support the wheel. The wheel 30 may also include set pins 818.

In one embodiment, Wheel 8W is a reverse cam bearing for one way-push button. Wheel 8W is a bearing gear system, whereas a push of the button allows the wheel to forward for tension or reverse to loosen like the radion bearing ¾″ ratchets on the market by pushing the forward or reverse button allows the bearing to roll in one direction, or pulling roll in the other direction.

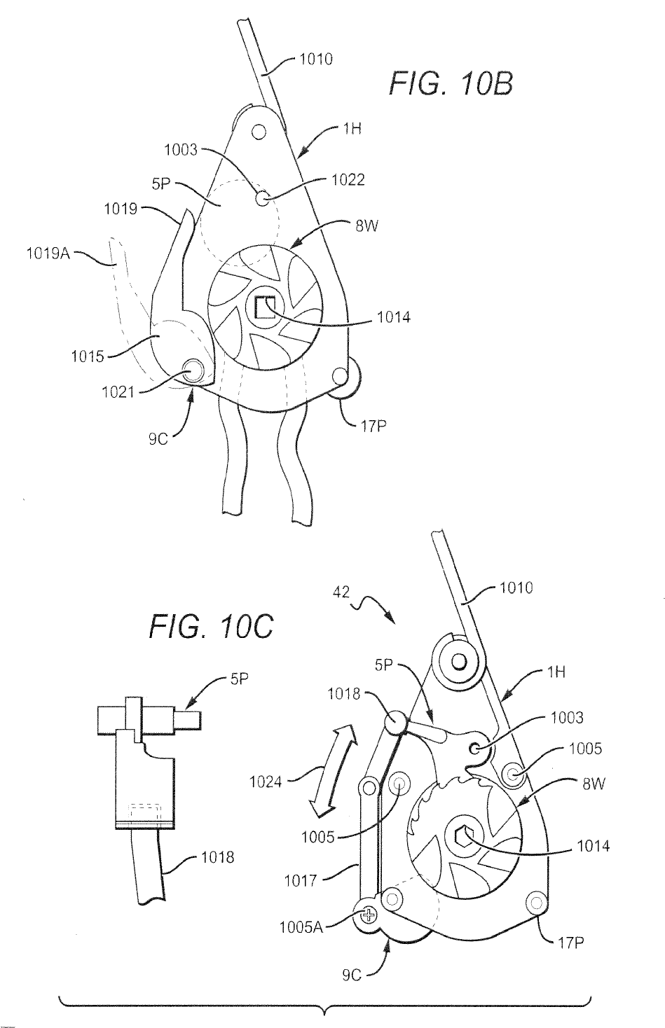

FIG. 9A-9E illustrates a representative cam 9C according to embodiments of the invention, which interacts with the wheel of FIG. 8 to increase cord grip between the wheel and cam. The cam 9C may have a outer edge surface that is shaped and textured to improve cord grip. The outer edge surface may be U-shaped, V-shaped, or straight. The surface may additionally include corresponding patterns and designs as the wheel to better grip the cord. FIG. 9A illustrates a representative cam 9C with a U-shaped outer edge groove 812. The U-shape profile is inverted, cutting into the cam interior body, so that when the wheel and cam are aligned, the cross-sectional space between them is generally circular, oblong, ovoid, or similarly shaped to accommodate the cord. FIG. 9B illustrates the cam 9C with U-shaped outer edge grove 812 including various gripping patterns. The surface of the cam 9C in contact with the cord or wheel may include various patterns to increase the grip between surfaces. For example, a star pattern 813 or other raised surface may be used; other gripping surfaces may include varying puzzle patterns 814A or 814B, spikes 815B, knurled pattern 815, or other friction increasing surface. FIG. 9C illustrates a cam 9C with V-shaped tapered outer edge surface 811. The patterns may be on the outer edge of cam 9C or may also be on the sides of the cam including the tapered portion 811. FIG. 9D illustrates different profile embodiments of the cam's 9C outer edge surface, including a square profile with and without tapered edges.

As seen in FIGS. 9A and 9C, the cam 9C may be in a half moon shape. FIG. 9E illustrates a representative cam 9C in a circular shape including V-shaped outer edge surface with tapered sides 811 and surface patterns including knurled pattern 815, puzzle pattern 814B, and stars 813 on the outer edge surface as well as the tapered edge surface. Cam 9C may include an offset hole 825 to couple to housing 1H by pin, screw, rivet, or other device. The offset hole, used to couple the cam to the housing permits the cam to permit the cord to pass easily when the wheel is rotated in one direction. However, when the wheel rotates in the opposite direction, the cam is pulled against the cord thereby putting pressure between the cord and the wheel to prevent slipping.

FIG. 10A-10E illustrates a representative ratchet pulley system according to embodiments of the invention including alternate embodiments of cam 9C. Cam 9C may be round or half moon shaped with an off-set hole 1022. Cam 1015 may additionally include a thumb grip. Ratchet pulley assembly may includes hook 1001, pawl 5P coupled to housing 1H with pawl pin 1003, wheel 8W coupled to housing with ratchet drive socket 1014, pulley 17P, and cam 9C coupled to housing with rivet 1021, according to embodiments of the invention.

FIG. 10A illustrates cam 9C according to embodiments of the present invention included in a ratchet assembly 40. In one embodiment, cam 1015 includes a U grove, as described above, on its outer edge. Cam 1015 may be coupled to housing 1002 by various devices known in the art. For example, cam 1015 may be coupled by screws to secure the cam to the housing. Alternatively, cam 1015 may be coupled to housing 1H by rivet screw pin, which provides an axis of rotation for the cam. The cam couple may also include bearing and race to provide smoother rotation. The coupling may also include spring 1006 to permit the cam 1015 to rotate and press against the wheel 8W as indicated by dashed line 1015a. By permitting the cam 1015 to rotate or slide away from the wheel, the cord may be easily positioned inside the ratchet assembly 40.

As seen in FIG. 10B, an alternate embodiment of cam 1015 may include handle 1019. Handle 1019 may be used to rotate the cam 1015 away or against the wheel 8W as indicated by dotted line 1019a. The handle 1019 may be integrated with cam 1015 or may be fitted over the cam. For example, handle 1019 may snap over cam 1015 and therefore remain removable. Handle 1019 may be used as a safety feature where a particular position of the handle locks the cam 1015 in place, but may include an emergency release. The cam handle may also include a tensioning device, such as a screw, to adjust the tension on the cord in a locking position. The handle may also include an unlocking free-wheeling position to place the handle out of the way.

FIG. 10C illustrates an alternate embodiment of ratchet pulley assembly 42 including handle 1017. Handle 1017 couples the cam 9C to pawl 5P to release and engage the ratchet pulley system 42 in one motion 1024. When the handle 1017 is lifted, the pawl 5P and cam 9C will release to permit wheel 8W to rotate freely and disengage cord (not shown). When the handle 1017 is lowered, the pawl 5P and cam 9C simultaneously engage wheel 8W and cord to secure cord and ratchet system. Handle 1017 may be jointed and couple to cam and pawl to permit relative rotation at the joint. For example, pawl 5P may be coupled to handle 1017 by a snap fit 1018, while cam 9C is coupled to handle 1017 by a screw 1005a.

FIG. 10D illustrates an alternate embodiment of the ratchet pulley assembly 44 according to embodiments of the invention including cam 9C coupled to hook 1019. The body 1002 may include a housing guide 1020 to support the hook body 1019 coupled to housing by screws or rivets 1005.

The cam 9C is coupled to hook 1019 by rivet 1011, pivots about 1021 to contact wheel 8W and engage cord (not shown). Once under pressure, the weight on the ratchet pulley assembly 44 engages the cam 9C. The more weight or tension on the system, the more grip of the cam and wheel. The cam and wheel may also include a textured surface to further increase its grip, including knurled grip, puzzled pieces, spikes, pyramid triangle teeth, stars, (all ranging in height and size) as disclosed above.

FIG. 10E illustrates a representative ratchet assembly according to embodiments of the present invention where the cam 9C is permitted to move. The cam 9C is a spring loaded 1006. Cam 9C is permitted to move along gear channel 1012 for axis of cam roller. Cam 9C engages the cord with a push of your thumb along with the pulling tension of the cord, sets the cam to lock position, stopping the cord from continuing through the unit.

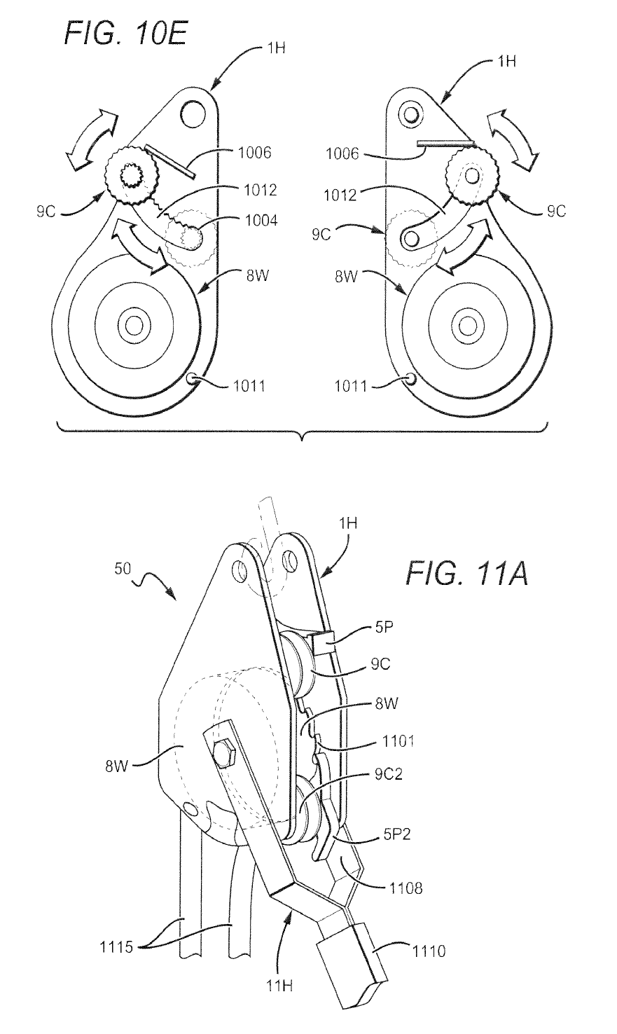

FIG. 11A-11B illustrates ratchet pulley assembly 50 according to embodiments of the invention including a handle 11H. Ratchet pulley assembly 50 may include one or more cams 9C and one or more pawls 5P. FIG. 11A illustrates a cam 9C and pawl 5P adjacent one another, with a pair on both the top and bottom side of the wheel 8W. Wheel 8W includes gear 1101 with teeth to interact with pawl 5P. Therefore, cord 1115 enters housing 1H, wraps around wheel 8W, while cam 9C pushes the cord again the wheel to increase the grip. The cord 1115 continues around the wheel 8W and is held against the wheel by a second cam 9C2, thereby increasing the total circumference of the wheel in contact with the cord and increasing the total frictional grip between the cord and wheel.

FIG. 11A illustrates one embodiment of the handle 11H. Handle 1108 couples to the wheel 8W through housing 1H and may be used to rotate the wheel. Alternatively, the handle 1108 may be coupled to the gear with a cam. As illustrated, the handle 1108 is coupled to the wheel 8W on the outside of the housing 1H and is attached to the axis of the wheel. The handle may be used in conjunction with the pawl 5P and cam 9C to positive drive the wheel 8W and gear 1101 forward and to aid in the ease of the release of the cord by allowing the user to slowly reverse the pull of the rope to release tension. Handle 1108 may include a rubber coated portion 1110 for comfort.

FIG. 11B illustrates an alternate embodiment of the pulley ratchet assembly 50 with handle 11H, which permits the user to crank the ratchet increasing tension in cord 1115. Ratchet pulley assembly 50 includes four pulleys 17P to ensure that the cord rests against the wheel 8W. Handle 1108 rotates about wheel axis and includes a pawl 5P2. Main pawl 5P includes a trigger or thumb release 1128 and act as the main lock. Pawls 5P and 5P2 are spring loaded 1106.

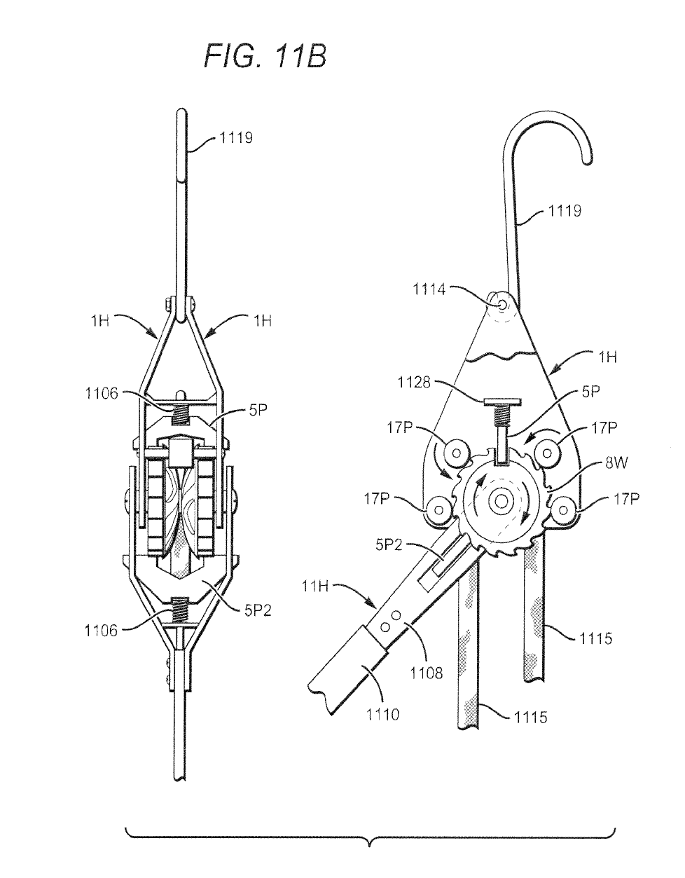

FIG. 12A-12B illustrates an alternate embodiment including handle 11H coupled to secondary cam 9C2 and including separate main cam 9C and pawl 5P. Cam 9C interacts with wheel 8W and cord 1115, while pawl 5P interacts with gear of wheel 8W. Handle 1208 may be covered with a comfort grip 1210, such as rubber. Handle 1208 lies inside housing 1H, with secondary cam 9C2 and pawl 5P2 coupled to handle 1208. Pulley 17P may also be coupled to housing 1H to direct the cord.

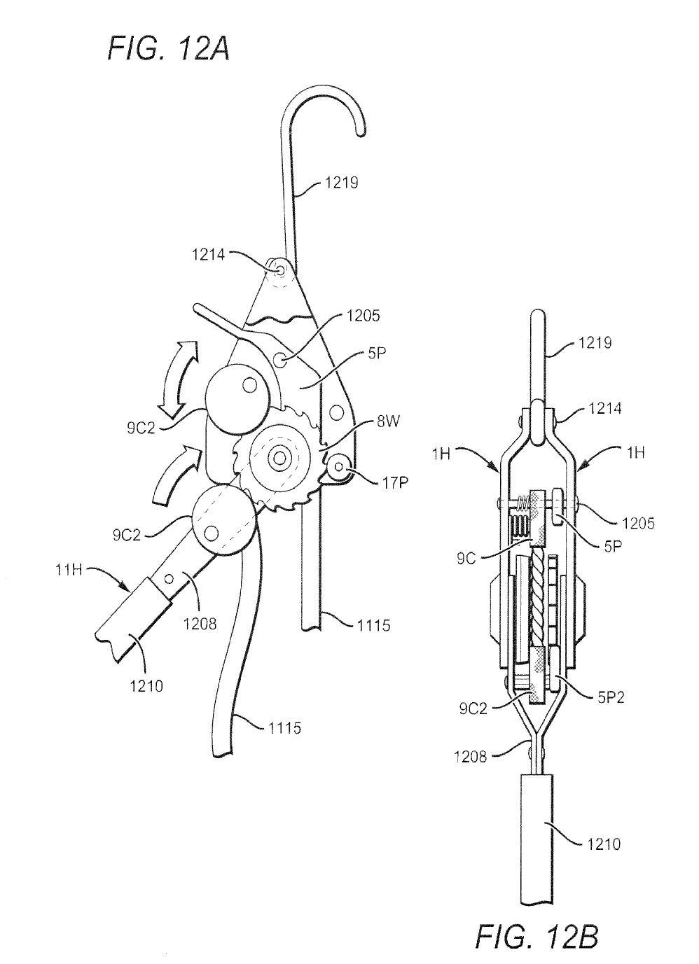

FIGS. 13A-13C illustrate alternate embodiment of handle 11H, where FIG. 13A illustrates in an open position with the handle down, FIG. 13B illustrates the handle in transition, and FIG. 13C illustrates a closed position where the handle is up. When the handle is open, as in FIG. 13A, the main cam 9C and secondary cam 9C2 may be engaged or disengaged. When the handle 11H is up or closed, as in FIG. 13C, the main cam is locked by the handle against the wheel or cord.

The second cam 9C2 is coupled directly to handle 1308 by screw 1305. Handle 1308 is coupled to wheel 8W by a screw 1305, and a hex key 1312 may be used to hold the handle in place. Cam 9C2 may be spring loaded to ensure pressure again cord and wheel. Handle 1308 may also include a groove 1309 with release 1309 to release the spring cam 9C2 and permit the cam to rotate away from the wheel. Alternatively, when the handle is raised, the cam rolls back free, and when the handle is pulled forward the cam rolls forward to engage the grip in the cord 1315 and the wheel allowing the pressure to rotate the wheel to tension to rope pulling the weight or load tighter. Housing 1H may include groove 1311 near the bottom to act as a stop and to prevent release of the main cam.

Main cam 9C is shown in an outline in FIG. 13B, which may also be spring loaded 1306. Housing 1H may include a groove 1313 to accommodate a pin 1313A coupled to cam 9C. Cam 9C may rotate about is axis, which is the axis coupled to the housing. Handle 1308 may also include an indention 1317 to interact with pin 1313A to lock the pin in position and therefore position the main cam 9C when the handle is raised. When the handle 1308 is lowered, the spring 1306 biases main cam 9C against wheel 8W and engage cord.

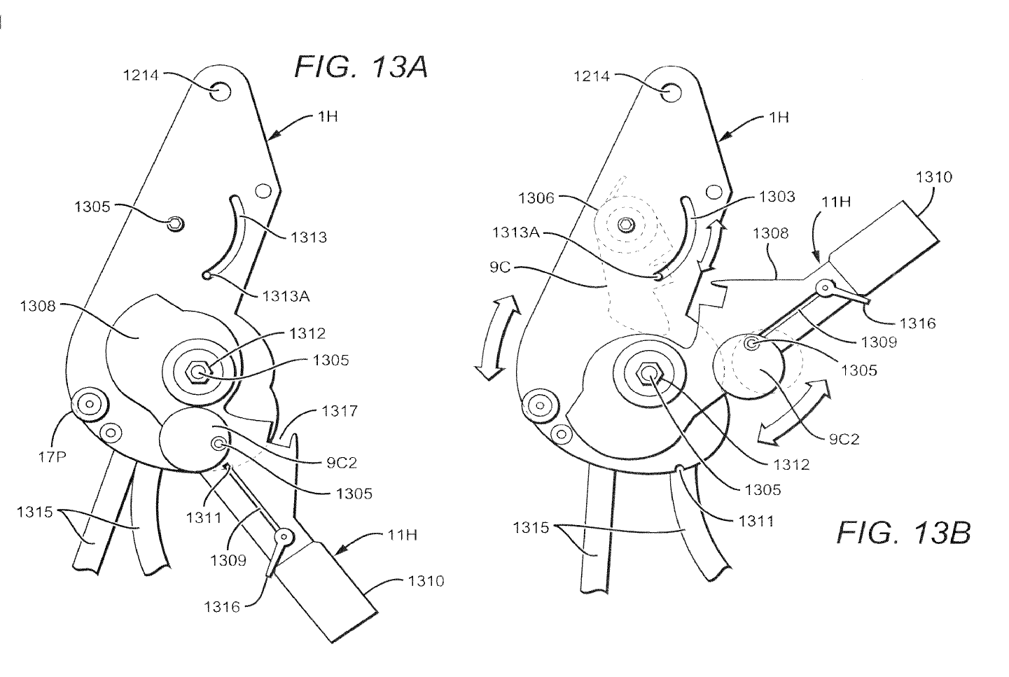

FIG. 14A-14B illustrates an pulley ratchet assembly according to embodiments of the invention including handles to lock the pulley preventing movement in either direction. Cord 1415 enters housing 1H through a space in the bottom. Housing support 1412 may be included to close the entrance gap and direct the cord. The cord 1415 then wraps around wheel 8W. The wheel 8W is permitted to rotate in only a single direction, as pawl 5P interferingly engages with teeth 1408 on the wheel gear. Spring 1407 is round with tails to bias pawl 5P against wheel 8W while permitting pawl 5P to slide over teeth 1408. Pulley 17P Cord 1415 then passes by cam 9C before exiting the housing 1H. Housing 1H may include housing support wall 1411 for a cam lock stop.

Wheel 8W may be coupled to handle 1406. Handle 1406 may be used to rotate wheel 1401 and increase the tension on cord 1415. The hex 1413 of wheel 8W supports handle 1406 and permits the handle to rotate. The handle 1406 is coupled to cam 9C by pull spring 1407. When the handle 1406 rotates to tighten the cord 1415, the rotation of the handle reduces the pull on the spring 1407, which releases pressure on cam 9C and permits the cord to move through the housing exit. When the handle 1406 is rotated in the opposite direction, the spring 1407 pulls against cam 9C, and the cord 1415 is caught between the cam 9C and the housing support 1411, preventing the cord to slip. The ratchet may also include a cam lock handle 1409, which puts pressure against cam 9C regardless of wheel handle 1406 location preventing cord movement.

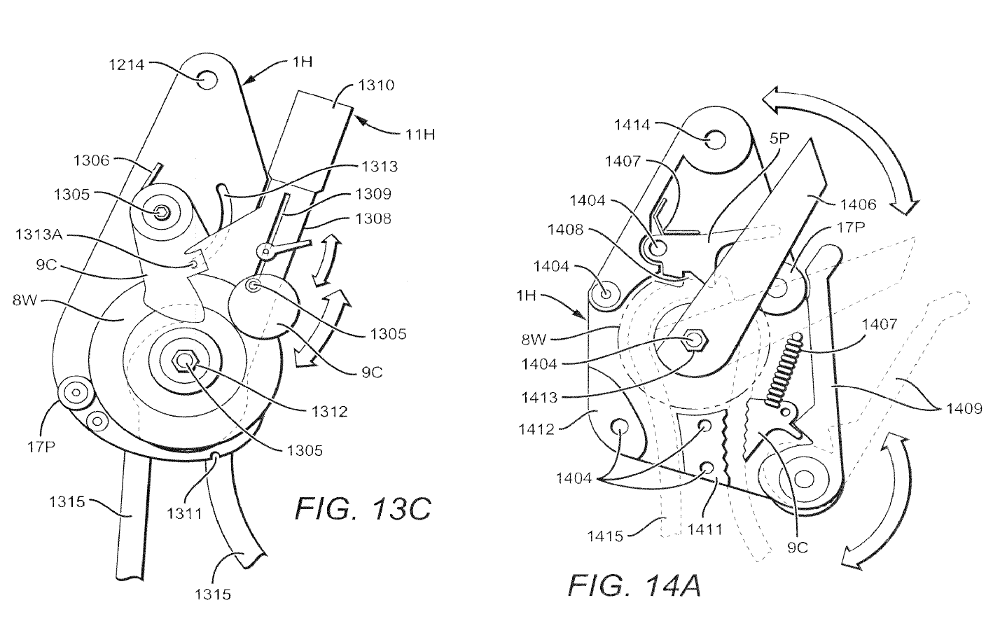

FIG. 15A-15D illustrates a representative pulley ratchet assembly according to embodiments of the invention including an alternate embodiment of the handle 11 H. FIG. 15 illustrates the use of a cam handle 1522A applying pressure on a swing arm 1524 that reaches across the bottom of the assembly and couples to the right pulley 17P, where the second swing arm 1525 couples to the left pulley 17P2. When cam handle 1522A is engaged, the system pushes the cord into the center bottom cord separator or stop block 1535, which may be textured, such as by ridges, puzzles, stars, triangles, pyramids for gripping. This provides the unit a locking safety ability.

FIG. 15C illustrates the pulley ratchet assembly of FIGS. 15A and 15B including a gear on the outside of pulley 17P and 17P2, with a round pin to roll in the wing arm 1524, permitting the pulley assembly to move and engage the cord with the center surface. Cam handle 1522A. In this embodiment, ratchet assembly also includes pulley arm 1524 that pulls when the cam handle 1522A is engaged. As seen in FIG. 15C, pulley arm 1524 may include a guide strip cut out at its end near the cam handle 1514 to allow a short pulley arm pin to move freely. The short pulley arm 1525 includes a pin that is pushed inward when the cam is engaged to force the pulley to engage the center cord striper 1535 and lock both ropes in position. Pulleys 17P and 17P2 may also be coupled to molded gear channels 1526 for pulleys to roll in to and from center.

FIG. 15D is a bottom view illustrating a curved plate 1520. A screw tensioning cam handle 1522 permits tension adjustments on the cord while locked, or permits an unlocked free wheel position that permits the handle 1522 to be placed out of the way. This embodiment includes a curved base bottom plate 1520, with corresponding housing humps 1523 with grooves to support opposite side for curved base lock at the cam handle. Cam handle 1522 is used to adjust thread rod to curved base to lift in to lock position. Coupled to housing 1H and cam handle 1522 and curved buse bottom plate 1520 is a spring and threaded adjustable screw 1521. As the cam handle 1522 is rotated, the curved buse bottom plate 1520 is either moved toward or away from the cam handle, thereby squeezing or releasing the cord between the bottom plate 1520 and associated housing humps 1523. Therefore, the cord is permitted to move freely or be locked in place.

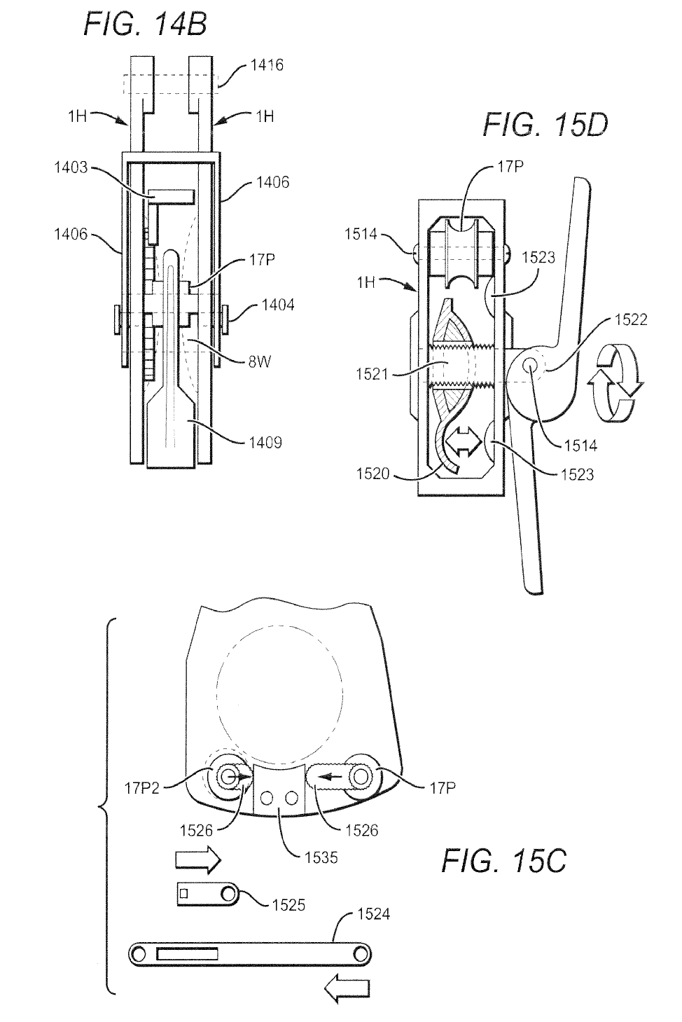

FIG. 16 illustrates a representative ratchet pulley with a disengage bar 1618. Disengage bar 1518 is coupled to housing 1H by rivet 1614. Cord 1615 coils around wheel 8W, while pawl 5P interact with gear 1601 to permit the cord to move in only one direction. Disengage bar 1618 pulls the rope out of wheel 8W to exit the housing 1H.

FIG. 17 illustrates pulley ratchet system 60 according to embodiments of the invention, including pulleys 17P. Pulleys 17P may be coupled to housing 1H by screws 1705. Pulley 17P at the bottom of the housing 1H, may be both on the right and the left side of the wheel 8W or just the front or right side of the wheel 8W. Pulley 17P will ease the flow of the cord 1709 rather than allow the cord to rub or drag under friction across the housing 1H surfaces while engaging the cord in the wheel.

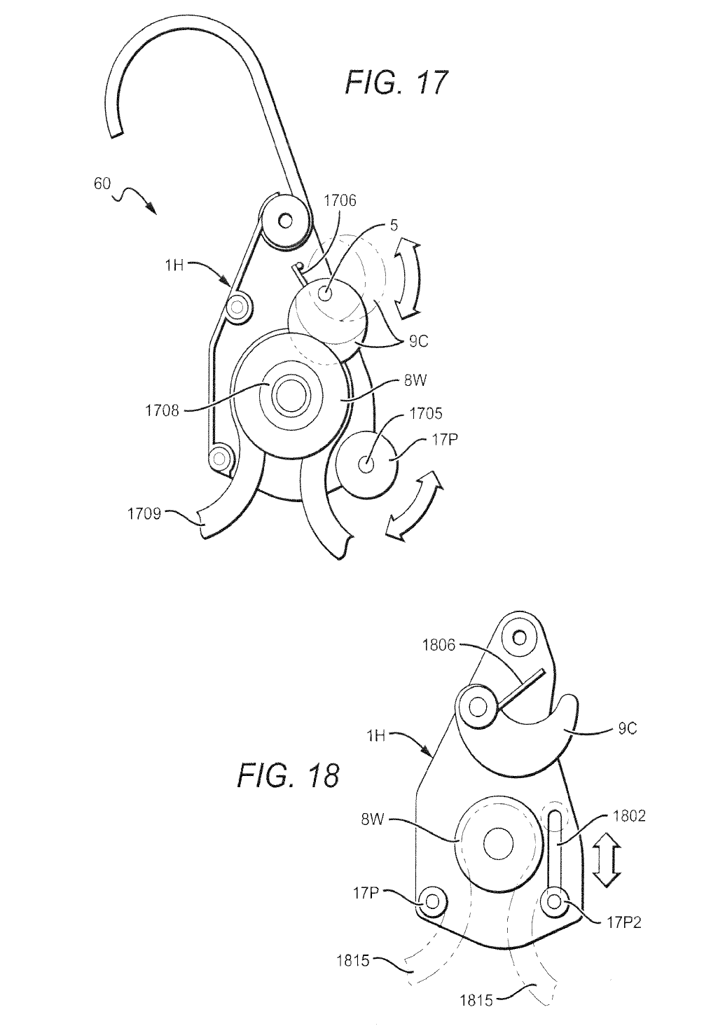

FIG. 18 illustrates a free flowing one direction pulley cam to help lock the cord in place once tension has been reached. Cam 9C is spring loaded 1806 against wheel 8W. Pulleys 17P and 17P2 direct cord 1815 around wheel 8W. Pulley 17P2 is permitted to move along gear channel 1802 for bottom housing gripping for safety and loading.

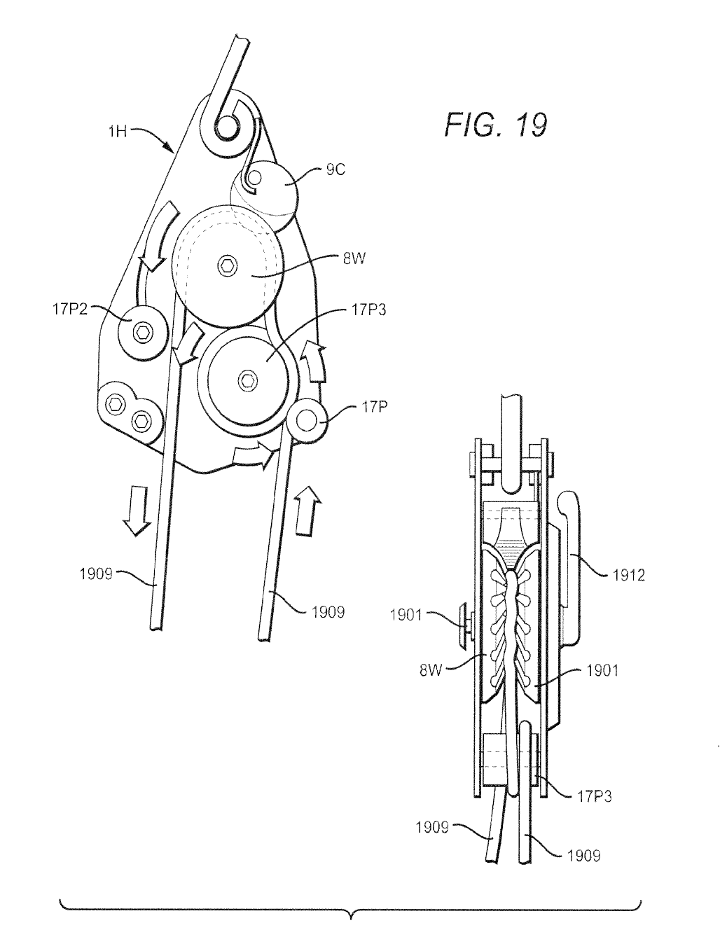

FIG. 19 illustrates a ratchet pulley assembly including additional wheel bearing surfaces to add strength. Cord 1909 wraps around bearing wheel pulley 17P3 at least once, but may be multiple times, then continues around the wheel 8W with the cam lock and half side, full side, inside, or outside mounted handle 1912 for rotating the wheel in either direction. Bearing race pulley 17P3 supports the cord weight on the entry side of ratchet assembly reducing the backward pull on wheel 8W. Bearing race pulley 17P3 is permitted to support the main tensions being applied, the weight, allowing the wheel 8W to work on gripping the cord 1909 and to tension device. Pulley 17P2 on the opposing side of the wheel 8W is a cam pulley. When the ratchet assembly is in use, pulley 17P2 is in a free-wheeling open position. The pulley 17P2 can be pulled up to lock the cord 1909 between pulley 17P2 and wheel 8W. Opposing faces of pulley 17P2 and wheel 8W may include ridges to lock the cord once tightened.

It is important to note that ratcheted pulley apparatus embodies numerous novel features that, individually and in combination, distinguish it from prior art of ratchets. As such, it may be characterized in a number of ways using one or more of such features. The following paragraphs provide some exemplary characterizations, but the list is not exhaustive as other combinations are contemplated and would be readily apparent to one of average skill in the art after reading the disclosure.

We claim:

1. A ratchet for use with a cord, the ratchet comprising:
a first and second body rotatably coupled to one another to form a housing, wherein the first body can swing with respect to the second body to permit access to an interior of the housing; and
a wheel, coupled to the housing, having first and second sections that have interior faces forming a cavity to support the cord.

2. The ratchet of claim 1, further comprising an opening in the housing to permit the cord to enter and exit the interior of the housing, wherein the opening is smaller than a diameter of the wheel.

3. The ratchet of claim 1, wherein the housing is secured in a closed position by a push button.

4. The ratchet of claim 1, wherein the housing is secured in a closed position by bearing lock pins.

5. The ratchet of claim 1, further comprising at least one pulley coupled to housing at a cord access hole in the housing to reduce frictional wear on the cord from rubbing against the housing.

6. The ratchet of claim 1, further comprising at least one pulley coupled to housing and positions to keep the cord in contact with more than half of a circumference of the wheel.

7. The ratchet of claim 1, wherein the interior face of the first section has a plurality of first ribs and the interior face of the second section has a plurality of second ribs to grip the cord, wherein the plurality of first and second ribs project into the cavity between the first and second sections.

8. The ratchet of claim 7, wherein the plurality of first and second ribs extend generally from a center of the first and second sections to an edge of the first and second sections.

9. The ratchet of claim 8, wherein the plurality of first and second ribs are flared.

10. The ratchet of claim 8, wherein the plurality of first and second ribs are rectilinear.

11. The ratchet of claim 8, wherein the plurality of first and second ribs are non-radial.

12. The ratchet of claim 8, wherein the plurality of first and second ribs are non-radial, rectilinear, and flared.

13. The ratchet of claim 7, wherein the plurality of first and second ribs form a generally V-shaped profile within the cavity between the first and second sections.

14. The ratchet of claim 1, wherein the interior faces of the first and second sections are textured to further grip the cord.

15. The ratchet of claim 1, further comprising a cam coupled to the housing to reduce slipping between the cord and wheel.

16. The ratchet of claim 15, wherein the cam is spring loaded to permit the cam to rotate away from the wheel.

17. The ratchet of claim 15, wherein the cam is spring loaded to permit the cam to slide away from the wheel.

18. The ratchet of claim 15, wherein the cam is rotatably coupled to housing, wherein an axis of rotation of the cam is off centered.

19. The ratchet of claim 18, wherein the cam is configured to permit the wheel to rotate in one direction and permit the cord to easily pass, but grip the cord when the wheel rotates in an opposite direction.

20. The ratchet of claim 1, further comprising a pawl coupled to the housing, wherein the pawl permits the wheel to rotate in one direction but prevents rotation in a reverse direction.

21. The ratchet of claim 20, wherein the pawl includes at least two teeth to interferingly engage a set of teeth on the wheel to prevent the rotation in the reverse direction.

22. The ratchet of claim 20, further comprising a shoulder in the housing to support a notch in the pawl when the ratchet is support weight and the pawl is preventing the rotation in the reverse direction.

23. The ratchet of claim 20, wherein the pawl includes a thumb release for selectively limiting rotation of the wheel.

24. The ratchet of claim 1, further comprising a handle coupled to the housing.
